(19) United States
(12) Patent Application Publication
(10) Pub. No.: US 2026/0046584 A1
(43) Pub. Date: Feb. 12, 2026

(54) APPARATUS AND METHOD FOR PREDICTING VOXEL COORDINATES FOR AR/VR SYSTEMS

(71) Applicant: Fraunhofer-Gesellschaft zur Förderung der angewandten Forschung e.V., München (DE)

(72) Inventor: Christian BORSS, Erlangen (DE)

(21) Appl. No.: 19/244,069

(22) Filed: Jun. 20, 2025

Related U.S. Application Data
(63) Continuation of application No. PCT/EP2023/086083, filed on Dec. 15, 2023.

(30) Foreign Application Priority Data
Dec. 23, 2022 (EP) 22216666.2

(51) Int. Cl. H04S 7/00; G06T 7/73; G06T 19/00

(52) U.S. Cl. CPC H04S 7/302; G06T 7/73; G06T 19/00; H04S 7/305; H04S 2400/11

(57) ABSTRACT

An apparatus is provided, which comprises a receiving interface, wherein the receiving interface is configured for receiving first data comprising information on one or more acoustic properties of an environment and/or one or more objects of an environment comprising acoustic properties and/or comprising one or more audio signals and/or comprising metadata on the one or more audio signals and/or comprising video data. Moreover, the receiving interface is configured the receiving interface is configured for receiving spatial data, wherein the spatial data defines at least one area or at least one spatial volume; wherein the first data is associated with the spatial data. The apparatus furthermore comprises a data processor configured for processing the first data to obtain processed data depending on the spatial data.

### CROSS-REFERENCE TO RELATED APPLICATIONS

This application is a continuation of copending International Application No. PCT/EP2023/086083, filed Dec. 15, 2023, which is incorporated herein by reference in its entirety, and additionally claims priority from European Application No. EP EP22216666.2, filed Dec. 23, 2022, which is also incorporated herein by reference in its entirety.

The present invention relates to encoding and decoding of coordinates, and to encoding and decoding or predicting voxel coordinates, and to an apparatus and method for predicting voxel coordinates for AR/VR systems. Some embodiments relate to auralization, e.g., real-time and offline audio rendering of auditory scenes and environments [1]. This includes Virtual Reality (VR) and Augmented Reality (AR) systems like the MPEG-I 6-DoF audio renderer.

### BACKGROUND OF THE INVENTION

In AR/VR systems voxel data is used to store metadata that is specific for a certain cube-shaped region. A bitstream, which stores this information, needs to specify the voxel coordinate for which the current data block is valid. For a large number of voxels, these voxel coordinates can contribute significantly to the total bitstream size.

In the current version of the MPEG-I working draft of RM0, voxel coordinates are transmitted as 16 bit unsigned integer numbers [1]:

TABLE 1
Syntax of diffrListenerVoxelDict( )

| Syntax | No. of bits | Mnemonic |
|---|---|---|
| diffrListenerVoxelDict( ) | | |
| { | | |
| numberOfListenerVoxels; | 32 | uimsbf |
| for (int i = 0; i < numberOfListenerVoxels; i++){ | | |
| listenerVoxelGridIndexX[i]; | 16 | uimsbf |
| listenerVoxelGridIndexY[i]; | 16 | uimsbf |
| listenerVoxelGridIndexZ[i]; | 16 | uimsbf |
| numberOfEdgesPerListenerVoxel; | 16 | uimsbf |
| for (int j = 0; j < numberOfEdgesPerListenerVoxel; j++){ | | |
| listenerVisibleEdgeId[i][j] = GetID( ); | | |
| } | | |
| } | | |
| } | | |

For a large number of voxels these 48 bits can sum up to a significant part of the total bitstream size.

Entropy encoding methods like Huffman encoding or pre-defined code tables for certain symbol distributions are widely used to reduce the size of transmitted symbols. The Generic Codebook encoding method is used to efficiently transmit early reflection metadata [2]. However, these methods do not exploit the redundancy of sequentially transmitted voxel coordinates.

### SUMMARY

According to an embodiment, an apparatus may have: a receiving interface, wherein the receiving interface is configured for receiving first data comprising information on one or more acoustic properties of an environment and/or one or more objects of an environment having acoustic properties and/or one or more objects of an environment having acoustic properties and/or comprising one or more audio signals and/or comprising metadata on the one or more audio signals and/or comprising video data; and wherein the receiving interface is configured for receiving spatial data, wherein the spatial data defines at least one area or at least one spatial volume, wherein the first data is associated with the spatial data; and a data processor, configured for processing the first data to obtain processed data depending on the spatial data.

According to another embodiment, an apparatus may have: an output generator, wherein the output generator is configured for generating spatial data, wherein the spatial data defines at least one area or at least one spatial volume; an output interface for outputting first data and the spatial data; wherein the first data comprises information on one or more acoustic properties of an environment and/or one or more objects of an environment having acoustic properties and/or comprises one or more audio signals and/or comprises metadata on the one or more audio signals and/or comprises video data; wherein the first data is associated with the spatial data.

According to another embodiment, a system may have: an apparatus including: an output generator, wherein the output generator is configured for generating spatial data, wherein the spatial data defines at least one area or at least one spatial volume; an output interface for outputting first data and the spatial data; wherein the first data comprises information on one or more acoustic properties of an environment and/or one or more objects of an environment having acoustic properties and/or comprises one or more audio signals and/or comprises metadata on the one or more audio signals and/or comprises video data; wherein the first data is associated with the spatial data, and an apparatus including: a receiving interface, wherein the receiving interface is configured for receiving first data comprising information on one or more acoustic properties of an environment and/or one or more objects of an environment having acoustic properties and/or one or more objects of an environment having acoustic properties and/or comprising one or more audio signals and/or comprising metadata on the one or more audio signals and/or comprising video data; and wherein the receiving interface is configured for receiving spatial data, wherein the spatial data defines at least one area or at least one spatial volume, wherein the first data is associated with the spatial data; and a data processor, configured for processing the first data to obtain processed data depending on the spatial data, wherein the apparatus including a receiving interface, wherein the receiving interface is configured for receiving first data comprising information on one or more acoustic properties of an environment and/or one or more objects of an environment having acoustic properties and/or one or more objects of an environment having acoustic properties and/or comprising one or more audio signals and/or comprising metadata on the one or more audio signals and/or comprising video data; and wherein the receiving interface is configured for receiving spatial data, wherein the spatial data defines at least one area or at least one spatial volume, wherein the first data is associated with the spatial data; and a data processor, configured for processing the first data to obtain processed data depending on the spatial data is configured to receive the first data and the spatial data from the apparatus including an output generator, wherein the output generator is configured for generating spatial data, wherein the spatial data defines at least one area or at least one spatial volume; an output interface for outputting first data and the spatial data; wherein the first data comprises information on one or more acoustic properties of an environment and/or one or more objects of an environment having acoustic properties and/or comprises one or more audio signals and/or comprises metadata on the one or more audio signals and/or comprises video data; wherein the first data is associated with the spatial data.

According to another embodiment, a method may have the steps of: receiving first data comprising information on one or more acoustic properties of an environment and/or one or more objects of an environment having acoustic properties and/or comprising one or more audio signals and/or comprising metadata on the one or more audio signals and/or comprising video data; receiving spatial data, wherein the spatial data defines at least one area or at least one spatial volume, wherein the first data is associated with the spatial data; and processing the first data to obtain processed data depending on the spatial data.

According to another embodiment, a method may have the steps of: generating spatial data, wherein the spatial data defines at least one area or at least one spatial volume; and outputting first data and the spatial data; wherein the first data comprises information on one or more acoustic properties of an environment and/or one or more objects of an environment having acoustic properties and/or comprises one or more audio signals and/or comprises metadata on the one or more audio signals and/or comprises video data; wherein the first data is associated with the spatial data.

Another embodiment may have a non-transitory digital storage medium having a computer program stored thereon to perform the any of the inventive methods when said computer program is run by a computer.

An apparatus according to an embodiment is provided. The apparatus comprises a receiving interface, wherein the receiving interface is configured for receiving first data comprising information on one or more acoustic properties of an environment and/or one or more objects of an environment having acoustic properties and/or comprising one or more audio signals and/or comprising metadata on the one or more audio signals and/or comprising video data. Moreover, the receiving interface is configured the receiving interface is configured for receiving spatial data, wherein the spatial data defines at least one area or at least one spatial volume; wherein the first data is associated with the spatial data. The apparatus furthermore comprises a data processor configured for processing the first data to obtain processed data depending on the spatial data.

Moreover, an apparatus according to another embodiment is provided. The apparatus comprises an output generator. The output generator is configured for generating spatial data, wherein the spatial data defines at least one area or at least one spatial volume. Moreover, the apparatus comprises an output interface for outputting first data and the spatial data; wherein the first data comprises information on one or more acoustic properties of an environment and/or one or more objects of an environment having acoustic properties and/or comprises one or more audio signals and/or comprises metadata on the one or more audio signals and/or comprises video data; wherein the first data is associated with the spatial data.

Furthermore, a method according to an embodiment is provided. The method comprises:
Receiving first data comprising information on one or more acoustic properties of an environment and/or one or more objects of an environment having acoustic properties and/or comprising one or more audio signals and/or comprising metadata on the one or more audio signals and/or comprising video data.
Moreover, the receiving interface is configured the receiving interface is configured for receiving spatial data, wherein the spatial data defines at least one area or at least one spatial volume; wherein the first data is associated with the spatial data.
The apparatus furthermore comprises a data processor configured for processing the first data to obtain processed data depending on the spatial data.

Moreover, a method according to another embodiment is provided. The method comprises:
Generating spatial data, wherein the spatial data defines at least one area or at least one spatial volume. And:
Outputting first data and the spatial data; wherein the first data comprises information on one or more acoustic properties of an environment and/or one or more objects of an environment having acoustic properties and/or comprises one or more audio signals and/or comprises metadata on the one or more audio signals and/or comprises video data; wherein the first data is associated with the spatial data.

Furthermore, a computer program for implementing one of the above-described methods when being executed on a computer or signal processor is provided.

### BRIEF DESCRIPTION OF THE DRAWINGS

Embodiments of the present invention will be detailed subsequently referring to the appended drawings, in which:

FIG. 1 illustrates an apparatus according to an embodiment.

FIG. 2 illustrates an apparatus according to another embodiment.

FIG. 3 illustrates a system according to an embodiment comprising the apparatus of FIG. 2 and the apparatus of FIG. 1.

### DETAILED DESCRIPTION OF THE INVENTION

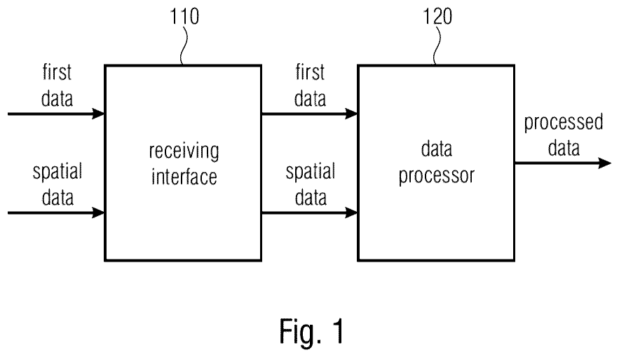

FIG. 1 illustrates an apparatus according to an embodiment.

The apparatus comprises a receiving interface 110, wherein the receiving interface 110 is configured for receiving first data comprising information on one or more acoustic properties of an environment and/or one or more objects of an environment having acoustic properties and/or comprising one or more audio signals and/or comprising metadata on the one or more audio signals and/or comprising video data.

Moreover, the receiving interface 110 is configured for receiving spatial data, wherein the spatial data defines at least one area or at least one spatial volume; wherein the first data is associated with the spatial data.

The apparatus furthermore comprises a data processor 120 configured for processing the first data to obtain processed data depending on the spatial data.

According to an embodiment, the spatial data may, e.g., comprise encoded position data. The encoded position data may, e.g., encode a plurality of positions, wherein the positions together define the at least one area or the at least one spatial volume; wherein the first data is associated with the plurality of positions. The data processor 120 may, e.g., be configured for decoding the encoded position data to obtain the plurality of positions.

E.g., the processing of the first data depending on the plurality of positions to obtain the processed data covers any kind of processing using the first data depending on the plurality of positions. For example, if the first data comprises information on an object in an environment, where reflections take place, for example, a wall, and if the plurality of positions determine the location of said wall, then calculating a reflected audio signal that is caused by an audio source signal and that is reflected at said wall, is such a kind of processing, and the reflected audio signal is such processed data. The same applies for a calculated signal that results from a diffraction.

According to an embodiment, the first data may, e.g., comprise said information on the one or more acoustic properties of the environment and/or may, e.g., comprise said one or more audio signals and/or may, e.g., comprise said metadata on the one or more audio signals.

In an embodiment, the apparatus may, e.g., comprise an audio signal generator for generating one or more audio output signals depending on the processed data.

According to an embodiment, the first data may, e.g., comprise said information on the one or more acoustic properties of the environment, which may, e.g., comprise information on one or more reflection objects and/or may, e.g., comprise information on one or more diffraction objects which are in a line-of-sight from a position of the plurality of positions.

In an embodiment, the first data may, e.g., comprise one or more audio source signals, wherein each audio source signal of the one or more audio source signals may, e.g., be associated with a position of the plurality of positions which indicates a sound source position of said audio source signal.

According to an embodiment, the first data may, e.g., comprise said video data.

In an embodiment, the apparatus may, e.g., comprise a video signal generator for generating one or more video output signals depending on the processed data.

According to an embodiment, the video signal generator may, e.g., be configured to generate the one or more video output signals comprising video data depending on the first data and depending on the plurality of positions.

In an embodiment, the audio signal generator may, e.g., be configured to generate the one or more audio output signals for an augmented reality application or for a virtual reality application. The video signal generator may, e.g., be configured to generate the one or more video output signals for the augmented reality application or for the virtual reality application.

According to an embodiment, the receiving interface 110 may, e.g., be configured to receive a data stream comprising the first data and the encoded position data.

In an embodiment, the receiving interface 110 may, e.g., be configured for receiving the encoded position data encoding the plurality of positions, being a plurality of positions of a coordinate system, which exhibits two or more dimensions.

In an embodiment, if coordinate information of the encoded position data for a first coordinate value of a considered position of the plurality of positions indicates a first state, the data processor 120 may, e.g., be configured to determine the first coordinate value of the considered position by incrementing or decrementing a first coordinate value of a previously decoded position of the plurality of positions. If the coordinate information of the encoded position data for the first coordinate value of the considered position indicates a second state being different from the first state, the data processor 120 may, e.g., be configured to determine the first coordinate value of the considered position without using the previously decoded position for determining the first coordinate value of the considered position.

According to an embodiment, if the coordinate information of the encoded position data for the first coordinate value of the considered position indicates the first state, the data processor 120 may, e.g., be configured to employ one or more other coordinate values of the previously decoded position as one or more other coordinate values of the considered position.

In an embodiment, the data stream may, e.g., comprise the first data immediately after coordinate information of one of two or more coordinate values of a position of the plurality of positions, with which the first data may, e.g., be associated. The apparatus may, e.g., be configured to obtain the first data from the data stream.

According to an embodiment, the first data of the data stream may, e.g., be encoded first data, wherein a portion of the encoded first data being associated with a first position of the plurality of positions may, e.g., be encoded depending on a portion of the encoded first data being associated with a second position of the plurality of positions.

In an embodiment, the second position exhibits a coordinate value immediately preceding or immediately succeeding a coordinate value of the first position among the plurality of positions with respect to a coordinate of the two or more coordinates of the coordinate system.

According to an embodiment, if the coordinate information of the encoded position data for the first coordinate value of the considered position indicates the second state, the data processor 120 may, e.g., be configured to determine the first coordinate value of the considered position from an entropy encoding of the first coordinate value within the data stream.

In an embodiment, if the coordinate information of the encoded position data for the first coordinate value of the considered position indicates the second state, the encoded position data may, e.g., comprise coordinate information for a second coordinate value of the considered position, and the data processor 120 may, e.g., be configured to determine the second coordinate value of the considered position depending on the coordinate information of the encoded position data for the second coordinate value.

According to an embodiment, if the coordinate information of the encoded position data for the second coordinate value of the considered position indicates a first state, the data processor 120 may, e.g., be configured to determine the second coordinate value of the considered position by incrementing or decrementing a second coordinate value of the previously decoded position of the plurality of positions. If the coordinate information of the encoded position data for second first coordinate value of the considered position indicates a second state being different from said first state, the data processor 120 may, e.g., be configured to determine the second coordinate value of the considered position from the data stream without using the previously decoded position for determining the second coordinate value of the considered position.

In an embodiment, the plurality of positions may, e.g., indicate a plurality of positions of voxels.

According to an embodiment, the spatial data may, e.g., comprise information on at least one rectangle to define the at least one area. Or, the spatial data may, e.g., comprise information at least one cuboid to define the at least one spatial volume.

In an embodiment, the plurality of positions of the coordinate system may, e.g., define the corners of the at least one rectangle. Or, the plurality of positions of the coordinate system define the corners of the at least one cuboid.

According to an embodiment, the spatial data may, e.g., comprises information on at least two rectangles to define the one of the at least one area. Or, the spatial data may, e.g., comprise information at least two cuboids to define one of the at least one spatial volume.

In an embodiment, the coordinate system exhibits more than three dimensions.

According to an embodiment, the spatial data comprises boundary data, wherein the boundary data defines the at least one area or the at least one spatial volume; wherein the first data is associated with the boundary data.

In an embodiment, the boundary data comprises a width and a height to define the at least one area being a two-dimensional area. Or, the boundary data comprises a width and a height and a length define the at least one area being a three-dimensional area.

According to an embodiment, the coordinate system exhibits more than three dimensions.

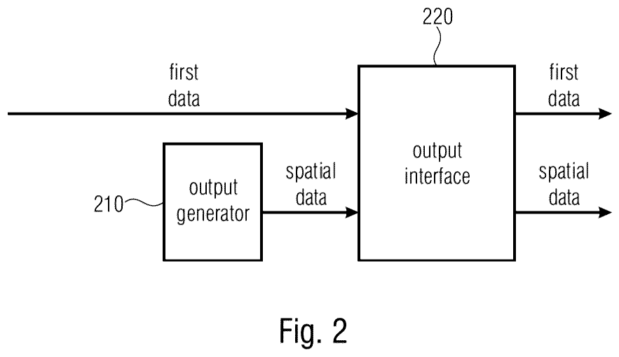

FIG. 2 illustrates an apparatus according to another embodiment.

Moreover, an apparatus according to another embodiment is provided.

The apparatus comprises an output generator 210. The output generator 210 is configured for generating spatial data, wherein the spatial data defines at least one area or at least one spatial volume.

Moreover, the apparatus comprises an output interface 220 for outputting first data and the spatial data; wherein the first data comprises information on one or more acoustic properties of an environment and/or one or more objects of an environment having acoustic properties and/or comprises one or more audio signals and/or comprises metadata on the one or more audio signals and/or comprises video data; wherein the first data is associated with the spatial data.

In an embodiment, the output generator 210 may, e.g., be configured to generate the spatial data such that the spatial data comprises encoded position data, wherein the encoded position data encodes a plurality of positions, wherein the positions together define the at least one area or the at least one spatial volume; wherein the first data is associated with the plurality of positions.

According to an embodiment, the first data may, e.g., comprise said information on the one or more acoustic properties of the environment and/or may, e.g., comprise said one or more audio signals and/or may, e.g., comprise said metadata on the one or more audio signals.

In an embodiment, the first data may, e.g., comprise said information on the one or more acoustic properties of the environment, which may, e.g., comprise information on one or more reflection objects and/or may, e.g., comprise information on one or more diffraction objects which are in a line-of-sight from a position of the plurality of positions.

According to an embodiment, the first data may, e.g., comprise one or more audio source signals, wherein each audio source signal of the one or more audio source signals may, e.g., be associated with a position of the plurality of positions which indicates a sound source position of said audio source signal.

In an embodiment, the first data may, e.g., comprise said video data.

According to an embodiment, the output generator 210 may, e.g., be configured to generate a data stream comprising the first data and the encoded position data. The output interface 220 may, e.g., be configured to output the data stream.

In an embodiment, the output generator 210 may, e.g., be configured to generate the encoded position data, such that the encoded position data encodes the plurality of positions, being a plurality of positions of a coordinate system, which exhibits two or more dimensions.

In an embodiment, the output generator 210 may, e.g., be configured to generate the encoded position data, such that the encoded position data may, e.g., comprise coordinate information for a first coordinate value of one of the plurality of positions, which indicates a first state, wherein the first state indicates that the first coordinate value of said one of the plurality of positions corresponds to a modified value being a first coordinate value of a previously encoded position of the plurality of positions which may, e.g., be incremented or decremented by a predefined value. The output generator 210 may, e.g., be configured to generate the encoded position data, such that the encoded position data may, e.g., comprise coordinate information for a first coordinate value of another one of the plurality of positions, which indicates a second state being different from the first state, wherein the second state indicates that the first coordinate value of said other one of the plurality of positions may, e.g., be comprised by or encoded within the encoded position data and may, e.g., be obtainable or decodable from the encoded position data without using a first coordinate value of any other one of the plurality of positions.

According to an embodiment, the first state indicates that one or more other coordinate values of said one of the plurality of positions correspond to one or more other coordinate values of the previously encoded position.

In an embodiment, the data stream may, e.g., comprise the first data immediately after coordinate information of one of two or more coordinate values of a position of the plurality of positions, with which the first data may, e.g., be associated.

According to an embodiment, the first data of the data stream may, e.g., be encoded first data, wherein a portion of the encoded first data being associated with a first position of the plurality of positions may, e.g., be encoded depending on a portion of the encoded first data being associated with a second position of the plurality of positions.

In an embodiment, the second position exhibits a coordinate value immediately preceding or immediately succeeding a coordinate value of the first position among the plurality of positions with respect to a coordinate of the two or more coordinates of the coordinate system.

According to an embodiment, the coordinate information of the encoded position data for the first coordinate value of said other one of the plurality of positions indicates the second state, and the encoding module may, e.g., be configured to generate the encoded position data such that the encoded position data may, e.g., comprise coordinate information for a second coordinate value of said other one of the plurality of positions.

In an embodiment, the output generator 210 may, e.g., be configured to generate the encoded position data, such that the encoded position data may, e.g., comprise coordinate information for the second coordinate value of said other one of the plurality of positions, which indicates a first state, wherein the first state indicates that the second coordinate value of said other one of the plurality of positions corresponds to another modified value being a second coordinate value of a previously encoded position of the plurality of positions which may, e.g., be incremented or decremented by another predefined value. Or, the output generator 210 may, e.g., be configured to generate the encoded position data, such that the encoded position data may, e.g., comprise coordinate information for the second coordinate value of said other one of the plurality of positions, which indicates a second state being different from the first state, wherein the second state indicates that the second coordinate value of said other one of the plurality of positions may, e.g., be comprised by or encoded within the encoded position data and may, e.g., be obtainable or decodable from the encoded position data without using a second coordinate value of any other one of the plurality of positions.

In an embodiment, the spatial data may, e.g., comprise information on at least one rectangle to define the at least one area. Or, the spatial data may, e.g., comprise information at least one cuboid to define the at least one spatial volume.

According to an embodiment, the plurality of positions of the coordinate system may, e.g., define the corners of the at least one rectangle. Or, the plurality of positions of the coordinate system may, e.g., define the corners of the at least one cuboid.

In an embodiment, the spatial data may, e.g., comprise information on at least two rectangles to define the one of the at least one area; or wherein the spatial data comprises information at least two cuboids to define one of the at least one spatial volume.

According to an embodiment, the coordinate system exhibits more than three dimensions.

In an embodiment, the spatial data comprises boundary data, wherein the boundary data defines the at least one area or the at least one spatial volume; wherein the first data is associated with the boundary data.

According to an embodiment, the boundary data comprises a width and a height to define the at least one area being a two-dimensional area. Or, the boundary data comprises a width and a height and a length define the at least one area being a three-dimensional area.

In an embodiment, the coordinate system exhibits more than three dimensions.

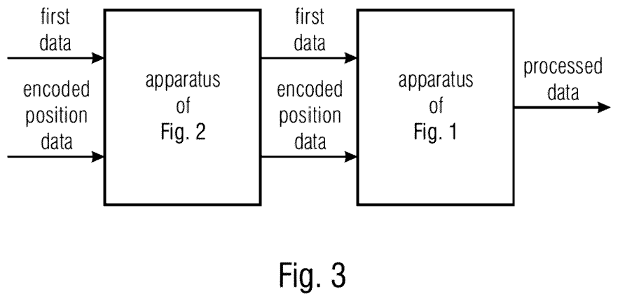

FIG. 3 illustrates a system according to an embodiment. The system comprises an apparatus of FIG. 2, and an apparatus of FIG. 1.

In the system of FIG. 3, the apparatus of FIG. 1 is configured to receive the first data and the spatial data from the apparatus of FIG. 2.

Now, particular embodiments are described:

The proposed concept exploits the similarity of consecutively transmitted voxel data. The RM0 MPEG-I encoder does not encode the voxel data in random order. Instead, the voxel data is serialized by iterating over one or more regions and for each region iterating over its x-, y-, and z-coordinates:

```
for (bbox : region_bounding_boxes) {
  for (int x = bbox.x0; x <= bbox.x1; x++) {
    for (int y = bbox.y0; y <= bbox.y1; y++) {
      for (int z = bbox.z0; z <= bbox.z1; z++) {
        if (has_voxel_data(x, y, z)) {
          bitstream.append( serialize_voxel_data(x, y, z) );
        }
      }
    }
  }
}
```

Consequently, the transmission of the voxel coordinates contains a lot of redundancy that can be reduced by predicting the voxel coordinate sequence according to the cascaded x/y/z loop.

The proposed method is especially beneficial, if the regions are boxes, but this is not a necessity.

According to a particular embodiment, the voxel coordinate sequence [xᵢ, yᵢ, zᵢ] is predicted as follows:

TABLE 2
Syntax of diffrListenerVoxelDict( )

| Syntax | No. of bits | Mnemonic |
|---|---|---|
| diffrListenerVoxelDict( ) | | |
| { | | |
| x = −1; | | |
| y = −1; | | |
| z = −1; | | |
| codebookVcX = genericCodebook( ); | | |
| codebookVcY = genericCodebook( ); | | |
| codebookVcZ = genericCodebook( ); | | |
| numberOfListenerVoxels; | 32 | uimsbf |
| for (int i = 0; i < numberOfListenerVoxels; i++){ | | |
| z += 1; | | |
| | 1 | uimsbf |
| hasVoxelCoordZ; | | |
| if (hasVoxelCoordZ) { | | |
| | | vlclbf |
| z = codebookVcZ.get_symbol( ); | | |
| | 1 | |
| | | uimsbf |
| y += 1; | | |
| | | vlclbf |
| hasVoxelCoordY; | | |
| | 1 | |
| if (hasVoxelCoordY) { | | |
| | | uimsbf |
| y = codebookVcY.get_symbol( ); | | |
| | | vlclbf |
| x += 1; | | |
| hasVoxelCoordX; | | |
| if (hasVoxelCoordX) { | | |
| x = codebookVcX.get_symbol( ); | | |
| } | | |
| } | | |
| } | | |
| listenerVoxelGridIndexX[i] = x; | | |
| listenerVoxelGridIndexY[i] = y; | | |
| listenerVoxelGridIndexZ[i] = z; | | |
| numberOfEdgesPerListenerVoxel; | 16 | uimsbf |
| for (int j = 0; j < numberOfEdgesPerListenerVoxel; j++){ | | |
| listenerVisibleEdgeId[i][j] = GetID( ); | | |
| } | | |
| } | | |
| } | | |

The proposed encoding method exploits the redundancy of sequentially transmitted voxel coordinates and hence reduces the bitstream size. In the targeted use case, hasVoxelCoordZ is 0 in most cases. The same holds for hasVoxelCoordY and hasVoxelCoordX. Consequently, in most cases the voxel coordinate is transmitted by a single bit.

In contrast, in the state-of-the-art no voxel coordinate prediction is used.

In the following, specific embodiments of the present invention are described in more detail.

Now, voxel coordinate prediction according to particular embodiments is described in more detail.

Regarding Voxel Coordinate Prediction according to embodiments, the RM1+ encoder does not encode the voxel data in random order. Instead, the voxel data is serialized by iterating over one or more regions and for each region iterating over its x-, y-, and z-coordinates:

```
for (bbox : region_bounding_boxes) {
  for (int x = bbox.x0; x <= bbox.x1; x++) {
    for (int y = bbox.y0; y <= bbox.y1; y++) {
      for (int z = bbox.z0; z <= bbox.z1; z++) {
        if (has_voxel_data(x, y, z)) {
          bitstream.append( serialize_voxel_data(x, y, z) );
        }
      }
    }
  }
}
```

Consequently, the voxel coordinates [x, y, z] are mostly predictable and a voxel coordinate predictor can be used to reduce the redundancy of the transmitted data. Due to the huge number of voxel coordinates within diffractionPayload( ) and their representation by three 16 bit integer values, a significant saving of bitstream size can be achieved.

The predictor assumes that only the z-axis component is increased. If this is not the case, he assumes that additionally only the y-axis value is increased. If this is also not the case, he assumes that additionally the x-axis value is increased:

```
payloadWithVoxelCoordinatePrediction( )
{
  x = −1;
  y = −1;
  z = −1;
  codebookVcX = genericCodebook( );
  codebookVcY = genericCodebook( );
  codebookVcZ = genericCodebook( );
  numberOfListenerVoxels;
  for (int i = 0; i < numberOfListenerVoxels; i++) {
    z += 1;
    hasVoxelCoordZ;
    if (hasVoxelCoordZ) {
      z = codebookVcZ.get_symbol( );
      y += 1;
      hasVoxelCoordY;
      if (hasVoxelCoordY) {
        y = codebookVcY.get_symbol( );
        x += 1;
        hasVoxelCoordX;
        if (hasVoxelCoordX) {
          x = codebookVcX.get_symbol( );
        }
      }
    }
    listenerVoxelGridIndexX[i] = x;
    listenerVoxelGridIndexY[i] = y;
    listenerVoxelGridIndexZ[i] = z;
    numberOfVoxelDataEntries;
    for (int j = 0; j < numberOfVoxelDataEntries; j++) {
      voxelData[i][j] = getVoxelData( );
    }
  }
}
```

As hasVoxelCoordZ is 0 in most cases, only a single bit is needed in most cases for transmitting the voxel coordinates [x, y, z].

In another embodiment, a rectangular decomposition, for example, a three-dimensional rectangular decomposition may, e.g., be employed, e.g., for transmitting the coordinates.

An example code according to a particular embodiment is presented in the following:

```
std::map<Vector3d, SpatialMetadata> spatial_database;
int num_blocks = bitstream.readInt( );
for (int b = 0; b < num_blocks; b++) {
  int x0 = bitstream.readInt( );
  int x1 = bitstream.readInt( );
  int y0 = bitstream.readInt( );
  int y1 = bitstream.readInt( );
  int z0 = bitstream.readInt( );
  int z1 = bitstream.readInt( );
  for (int x = x0; x <= x1; x++) {
    for (int y = y0; y <= y1; y++) {
      for (int z = z0; z <= z1; z++) {
        SpatialMetadata metadata = bitstream.readSpatialMetadata( );
        spatial_database.insert({ { x, y, z}, metadata });
      }
    }
  }
}
```

In a further embodiment, coordinate values, a width, a height and a length of the blocks is transmitted.

In the following, geometry data conversion according to particular embodiments is described:

Regarding geometry data conversion according to embodiments, the Early Reflection Stage and the Diffraction Stage have different requirements on the format of the geometry data (numbering of triangles/edges and usage of primitives), geometry data is currently transmitted several times. In addition to the geometry data of the individual geometric objects, there is a concatenated static mesh for the Early Reflection Stage and vertex data is transmitted a third time in diffractionPayload( ).

In order to avoid the redundant multiple transmission of geometric data, we introduce a geometry data converter which provides the geometry data in the needed format. The static mesh and the static geometric primitives (spheres, cylinders, and boxes) for the early reflection signal processing block is reconstructed by the geometry data conversion block by concatenating all geometry data, which matches a pre-defined combination of the bitstream elements isMeshStatic and primitiveType and the newly introduced bitstream elements isEarlyReflectionPrimitive and isEarlyReflectionMesh. The static mesh for the Diffraction Stage is reconstructed in a similar way by concatenating all geometry data which matches another pre-defined combination of these flags and values.

Since this conversion is done in the exact same manner on the encoder as well as on the decoder side, identical data is available on both sides of the transmission system. Hence both sides can use the same enumeration of surfaces and edges, if the same mesh approximation is used for the geometric primitives. This approximation is implemented by pre-defined tables for the mesh vertices and triangle definitions.

Regarding techniques to reduce the payload size, the following techniques (or a subgroup thereof) may, e.g., be applied according to embodiments to reduce the payload size. The techniques comprise:

Geometry data conversion: (see the general explanations above or the particular examples below): Geometry data of geometric objects are transmitted only once, and embodiments introduce a geometry data converter is introduced which generates different variants of this data for the Early Reflection Stage and the Diffraction Stage.

Voxel coordinate prediction: (see the general explanations above or the particular examples below): Embodiments introduce a voxel coordinate predictor is introduced which predicts consecutively transmitted voxel coordinates.

Entropy Coding: The generic codebook encoding schema introduced in m60434 is used for entropy coding of data series.

Inter-voxel redundancy reduction: The differential voxel data encoding schema introduced in m60434 is utilized to exploit the similarity of neighbor voxel data.

Data consolidation: Bitstream elements which are redundant and can be derived by the decoder from other bitstream elements are removed.

Quantization: Quantization with configurable quantization accuracy is used to replace single precision floating point values. With 24 bit quantization, the quantization error is comparable to the accuracy of the former single precision floating point values.

Regarding entropy coding, for bitstream elements which are embedded in loops, mostly the Generic Codebook technique, for example, introduced in m60434 may, e.g., be used.

Compared to the entropy encoding method realized by the writeCountOrIndex( ) function, generic codebooks provide entropy encoding tailored for the given series of symbols.

Regarding Inter-Voxel Redundancy Reduction, due to the structural similarity of the voxel data, the inter-voxel redundancy reduction method introduced in m60434 for early reflection voxel data is also applicable for diffrListenerVoxelDict( ) and diffrValidPathDict( ). This method transmits the differences between neighbor voxel data using a list of removal indices and a list of added voxel data elements.

Regarding Data Consolidation, most of the bitstream elements of diffrEdges( ) can be reconstructed by the decoder from a small sub-set of these elements. By removing the redundant elements, a significant saving of bitstream size can be achieved.

Regarding Quantization, the payload components diffrStaticPathDict( ) and diffrDynamicPaths( ) contain a bitstream element “angle” which is encoded in RM1+ as 32-bit single precission floating point value. By replacing these bitstream elements by quantized integer values with entropy encoding using the Generic Codebook method, a significant saving of bitstream size can be achieved. The quantization accuracy can be selected using the newly added “numBitsForAngle” bitstream element. With numBitsForAngle=24 as chosen in our experiments, the quantization error is in the same range as a single precision floating point value.

As outlined above, the current working draft for the MPEG-I 6DoF Audio specification (“second draft version of RM1”) uses a binary format for transmitting diffraction payload data. This binary format is not yet optimized for small bitstream sizes. Embodiments replace this binary format by an improved binary format which results in significantly smaller bitstream sizes.

In the following, proposed changes to the current working draft for the MPEG-I 6DoF Audio specification (“second draft version of RM1”) text are provided:

By applying embodiments, a substantial reductions of the size of the diffraction payload can be achieved as shown below.

The encoding method presented in this Core Experiment is meant as a replacement for major parts of diffractionPayload( ). The corresponding payload handler in the reference software for packets of type PLD_DIFFRACTION is meant to be replaced accordingly.

Furthermore, the meshes( ) and primitives( ) syntax is meant to be extended by an additional flag and the reference software is meant to be extended by a geometry data converter (within the SceneState component in the renderer).

The proposed changes to the working draft text are specified in the following sections.

Changes to the working draft are marked by highlighted text. Strikethrough text is used to mark text that shall be removed in the current working draft.

### Syntax→Diffraction Payload Syntax

In Section “6.2.4-Diffraction payload syntax” of the Working Draft, the syntax definitions shall be changed as follows:

TABLE XXX
Syntax of diffractionPayload( )

| | | |
|---|---|---|
| Syntax | No. of bits | Mnemonic |

```
diffractionPayload( )
{
  diffrVoxelGrid( );
  diffrStaticEdgeList( );
  diffrStaticPathDict( );
  diffrListenerVoxelDict( );
  diffrSourceVoxelDict( );
  diffrValidPathDict( );
  diffrDynamicEdges( );
  diffrDynamicPaths( );
}
```

TABLE XXX
Syntax of diffrVoxelGrid( )

| | | |
|---|---|---|
| | No. of | |
| Syntax | bits | Mnemonic |

```
diffrVoxelGrid( )
{
  [diffrVoxelOriginX;
  diffrVoxelOriginY;
  diffrVoxelOriginZ;] = GetPosition(isSmallScene)
  diffrVoxelPitchX = GetDistance(isSmallScene);
  diffrVoxelPitchY = GetDistance(isSmallScene);
  diffrVoxelPitchZ = GetDistance(isSmallScene);
  diffrVoxelShapeX = GetID( );
  diffrVoxelShapeY = GetID( );
  diffrVoxelShapeZ = GetID( );
}
```

TABLE XXX
Syntax of diffrStaticEdgeList( )

| | No. of | |
|---|---|---|
| Syntax | bits | Mnemonic |
| diffrStaticEdgeList( ) | 1 | |
| { | | |
| diffrHasStaticEdgeData; | | Uimsbf |
| if (diffrHasStaticEdgeData) { | | |
| codebookEdgeID = genericCodebook( ); | | |
| codebookVtxID = genericCodebook( ); | | |
| codebookTriID = genericCodebook( ); | | |
| numberOfStaticEdges = GetID( ); | | |
| for (int i = 0; i < numberOfStaticEdges; i++){ | | |
| staticEdge[i] = diffrEdges(codebookEdgeID, | | |
| codebookVtxID, | | |
| codebookTriID); | | |
| } | | |
| } | | |
| } | | |

TABLE XXX
Syntax of diffrEdges( )

| | No. of | |
|---|---|---|
| Syntax | bits | Mnemonic |
| diffrEdges(codebookEdgeID, codebookVtxID, | | |
| codebookTriID) | | |
| { | | |
| edgeId = codebookEdgeID.get_symbol( ); | | Vlclbf |
| edgeVertexId1 = codebookVtxID.get_symbol( ); | | Vlclbf |
| edgeVertexId2 = codebookVtxID.get_symbol( ); | | Vlclbf |
| [symbol] | | |
| [symbol] | | |
| [symbol] | | |
| [symbol] | | |
| [symbol] | | |
| [symbol] [symbol] | | |
| [symbol] | | |
| [symbol] | | |
| [symbol] | | |
| [symbol] | | |
| [symbol] | | |
| [symbol] [symbol] | | |
| [symbol] | | |
| edgeAdjacentTriangleID1 = | | vlclbf |
| codebookTriID.get_symbol( ); | | |
| edgeAdjacentTriangleID2 = | | vlclbf |
| codebookTriID.get_symbol( ); | | |
| [symbol] | | |
| [symbol] | | |
| [symbol] | | |
| [symbol] | | |
| [symbol] | | |
| [symbol] | | |
| [symbol] | | |
| [symbol] | | |
| [symbol] [symbol] | | |
| [symbol] | | |
| [symbol] | | |
| [symbol] [symbol] | | |
| [symbol] | | |
| [symbol] | | |
| [symbol] | | |
| [symbol] | | |
| [symbol] | | |
| [symbol] | | |
| [symbol] | | |
| [symbol] | | |
| [symbol] | [symbol] | [symbol] |
| [symbol] | | |
| [symbol] | | |
| [symbol] | | |
| [symbol] | | |
| [symbol] | | |
| [symbol] [symbol] | | |
| edgeIsRounded; | 1 | uimsbf |
| edgeIsRelevant; | 1 | uimsbf |
| } | | |

TABLE XXX
Syntax of diffrStaticPathDict( )

| Syntax | No. of bits | Mnemonic |
|---|---|---|
| diffrStaticPathDict( ) | | |

| Syntax | No. of bits | Mnemonic |
|---|---|---|
| { | 1 | uimsbf |
| diffrHasStaticPathData; | | |
| if (diffrHasStaticPathData) { | | |
| staticPathDict = diffrPathDict( ); | | |
| } | | |
| } | | |

TABLE XXX
Syntax of diffrPathDict( )

| | No. of | |
|---|---|---|
| Syntax | bits | Mnemonic |
| diffrPathDict( ) | | |
| { | | |
| codebookEdgeIDSeqLen = genericCodebook( ); | | |
| codebookEdgeIDSeq = genericCodebook( ); | | |
| codebookAngleSeq = genericCodebook( ); | | |
| numBitsForAngle; | 6 | uimsbf |
| numberOfRelevantEdges = GetID( ); | | |
| for (int i = 0; i < numberOfRelevantEdges; i++){ | | |
| numberOfPaths = GetID( ); | | |
| for (int j = 0; j < numberOfPaths; j++){ | | |
| numberOfEdgesInPath = | | vlclbf |
| codebookEdgeIDSeqLen.get_symbol( ); | | |
| for (int k = 0; i < numberOfEdgesInPath; | | |
| k++){ | | |
| edgeId[i][j][k] = | | vlclbf |
| codebookEdgeIDSeq.get_symbol( ); | | |
| faceIndicator[i][j][k]; | 1 | uimsbf |
| angle[i][j][k] = | | vlclbf |
| codebookAngleSeq.get_symbol( ); | | |
| } | | |
| } | | |
| } | | |
| } | | |

TABLE XXX
Syntax of diffrListenerVoxelDict( )

| Syntax | No. of bits | Mnemonic |
|---|---|---|
| diffrListenerVoxelDict( ) | | |
| { | | |
| diffrHasListenerVoxelData; | 1 | uimsbf |
| if (diffrHasListenerVoxelData) { | | |
| x = −1; | | |
| y = −1; | | |
| z = −1; | | |
| codebookVcX = genericCodebook( ); | | |
| codebookVcY = genericCodebook( ); | | |
| codebookVcZ = genericCodebook( ); | | |
| codebookNumEdges = genericCodebook( ); | | |
| codebookEdgeId = genericCodebook( ); | | |
| codebookIndicesRemoved = genericCodebook( ); | | |
| numberOfListenerVoxels = GetID( ); | | |
| for (int i = 0; i < numberOfListenerVoxels; i++){ | | |
| z += 1; | | |
| hasVoxelCoordZ; | 1 | uimsbf |
| if (hasVoxelCoordZ) { | | |
| z = codebookVcZ.get_symbol( ); | | vlclbf |
| y += 1; | | |
| hasVoxelCoordY; | 1 | uimsbf |
| if (hasVoxelCoordY) { | | |
| y = codebookVcY.get_symbol( ); | | vlclbf |
| x += 1; | | |
| hasVoxelCoordX; | 1 | uimsbf |
| if (hasVoxelCoordX) { | | |
| x = codebookVcX.get_symbol( ); | | vlclbf |
| } | | |
| } | | |
| } | | |
| listenerVoxelGridIndexX[i] = x; | | |

| Syntax | No. of bits | Mnemonic |
|---|---|---|
| listenerVoxelGridIndexY[i] = y; | | |
| listenerVoxelGridIndexZ[i] = z; | | |
| diffrListenerVoxelMode[i] | 2 | uimsbf |
| bool remove_loop = diffrListenerVoxelMode[i] != 0; | | |
| ink k = 0 | | |
| while (remove_loop) { | | |
| diffrListenerVoxelIndex[i][k] = | | vlclbf |
| codebookIndicesRemoved.get_symbol( ) | | |
| remove_loop = diffrListenerVoxelIndexDiff[i][k] != | | |
| 0; | | |
| k += 1; | | |
| } | | |
| | | vlclbf |
| numberOfEdgesAdded=codebookNumEdges.get_symbol( ); | | |
| for (int j = 0; j < numberOfEdgesAdded; j++){ | | |
| diffrListenerVoxelEdge[i][j] = | | vlclbf |
| codebookEdgeId.get_symbol( ); | | |
| } | | |
| } | | |
| } | | |
| } | | |

TABLE XXX
Syntax of diffrSourceVoxelDict( )

| | No. of | |
|---|---|---|
| Syntax | bits | Mnemonic |
| diffrSourceVoxelDict( ) | | |
| { | | |
| diffrHasSourceVoxelData; | 1 | uimsbf |
| if (diffrHasSourceVoxelData) { | | |
| numberOfStaticSources = GetID( ); | | |
| for (int i = 0; i < numberOfStaticSources; i++){ | | |
| staticSourceId = GetID( ); | | |
| numberOfVoxelsPerStaticSource = GetID( ); | | |
| | No. of | |
| Syntax | bits | Mnemonic |
| for (int j = 0; j < | | |
| numberOfVoxelsPerStaticSource; j++){ | | |
| sourceVoxelGridIndexX[i][j] = GetID( ); | | |
| sourceVoxelGridIndexY[i][j] = GetID( ); | | |
| sourceVoxelGridIndexZ[i][j] = GetID( ); | | |
| numberOfEdgesPerSourceVoxel = | | |
| GetID( ); | | |
| for (int k = 0; k < | | |
| numberOfEdgesPerSourceVoxel; k++){ | | |
| sourceVisibleEdgeld[i][j][k] = GetID( ); | | |
| } | | |
| } | | |
| } | | |
| } | | |
| } | | |

TABLE XXX
Syntax of diffrValidPathDict( )

| Syntax | No. of bits | Mnemonic |
|---|---|---|
| diffrValidPathDict( ) | | |
| { | | |
| diffrHasValidPathData; | 1 | uimsbf |
| if (diffrHasValidPathData) { | | |
| numberOfValidStaticSources = GetID( ); | | |
| for (int i = 0; i < numberOfValidStaticSources; i++){ | | |
| validStaticSourceId = GetID( ); | | |
| x = −1; | | |
| y = −1; | | |
| z = −1; | | |
| codebookVcX = genericCodebook( ); | | |
| codebookVcY = genericCodebook( ); | | |
| codebookVcZ = genericCodebook( ); | | |
| codebookNumPaths = genericCodebook( ); | | |
| codebookEdgeId = genericCodebook( ); | | |
| codebookPathId = genericCodebook( ); | | |
| codebookIndicesRemoved = genericCodebook( ); | | |
| numberOfMaximumListenerVoxels = GetID( ); | | |
| for (int j = 0; j < numberOfMaximumListenerVoxels; | | |
| j++){ | | |
| z += 1; | | |
| hasVoxelCoordZ; | 1 | uimsbf |
| if (hasVoxelCoordZ) { | | |
| z = codebookVcZ.get_symbol( ); | | vlclbf |
| y += 1; | | |
| hasVoxelCoordY; | 1 | uimsbf |
| if (hasVoxelCoordY) { | | |
| y = codebookVcY.get_symbol( ); | | vlclbf |
| x += 1; | | |
| hasVoxelCoordX; | 1 | uimsbf |
| if (hasVoxelCoordX) { | | |
| x = | | vlclbf |
| codebookVcX.get_symbol( ); | | |
| } | | |
| } | | |
| } | | |
| validListenerVoxelGridIndexX[i][j] = x; | | |
| validListenerVoxelGridIndexY[i][j] = y; | | |
| validListenerVoxelGridIndexZ[i][j] = z; | | |
| diffrValidPathMode[i][j]; | 2 | uimsbf |
| bool remove_loop = diffrValidPathMode[i][j] != 0; | | |
| int k = 0; | | |
| while (remove_loop) { | | |
| diffrValidPathIndexDiff[i][j][k] = | | vlclbf |
| codebookIndicesRemoved.get_symbol( ); | | |
| remove_loop = | | |
| diffrValidPathIndexDiff[i][j][k] != 0; | | |
| k += 1; | | |
| } | | |
| numberOfPathsAdded = | | vlclbf |
| codebookNumPaths.get_symbol( ); | | |
| for (int k = 0; k < numberOfPathsAdded; k++){ | | |
| diffrValidPathEdge[i][j][k] = | | vlclbf |
| codebookEdgeId.get_symbol( ); | | |
| diffrValidPathPath[i][j][k] = | | vlclbf |
| codebookPathId.get_symbol( ); | | |
| } | | |
| } | | |
| } | | |
| } | | |
| } | | |

TABLE XXX
Syntax of diffrDynamicEdges( )

| Syntax | No. of bits | Mnemonic |
|---|---|---|
| diffrDynamicEdges( ) | | |
| { | 1 | uimsbf |
| diffrHasDynamicEdgeData; | | |
| if (diffrHasDynamicEdgeData) { | | |
| dynamicGeometryCount = GetID( ); | | |
| for (int i = 0; i < dynamicGeometryCount; i++){ | | |
| geometryId[i] = GetID( ); | | |
| codebookEdgeID = genericCodebook( ); | | |
| codebookVtxID = genericCodebook( ); | | |
| codebookTriID = genericCodebook( ); | | |
| dynamicEdgesCount = GetID( ); | | |
| for (int j = 0; j < dynamicEdgesCount; j++) { | | |
| dynamicEdge[i][j] = diffrEdges(codebookEdgeID, | | |
| codebookVtxID, codebookTrilD); | | |
| } | | |
| } | | |
| } | | |
| } | | |

TABLE XXX
Syntax of diffrDynamicPaths( )

| | No. of | |
|---|---|---|
| Syntax | bits | Mnemonic |
| diffrDynamicPaths( ) | | |
| { | | |
| diffrHasDynamicPathData; | 1 | uimsbf |
| if (diffrHasDynamicPathData) { | | |
| dynamicGeometryCount = GetID( ); | | |
| for (int g = 0; g < dynamicGeometryCount; | | |
| g++){ | | |
| relevantGeometryId = GetID( ); | | |
| dynamicPathDict[g] = diffrPathDict( ); | | |
| } | | |
| } | | |
| } | | |

### Syntax→Scene Plus Payload Syntax

In Section “6.2.11-Scene plus payload syntax” of the Working draft, the following tables shall be extended:

TABLE XXX
Syntax of primitives( )

| Syntax | No. of bits | Mnemonic |
|---|---|---|
| primitives( ) | | |
| { | | |
| primitivesCount = GetCountOrIndex( ); | | |
| for (int i = 0; i < primitivesCount; i++) { | | |
| primitiveType; | 2 | uimsbf |
| primitiveId = GetId( ); | | |
| [primitivePositionX; | | |
| primitivePositionY; | | |
| primitivePositionZ;] = GetPosition(isSmallScene) | | |
| [primitiveOrientationYaw; | | |
| primitiveOrientationPitch; | | |
| primitiveOrientationRoll] = GetOrientation( ); | | |
| primitiveCoordSpace; | 1 | bslbf |
| primitiveSizeX = GetDistance(isSmallScene); | | |
| primitiveSizeY = GetDistance(isSmallScene); | | |
| primitiveSizeZ = GetDistance(isSmallScene); | | |
| primitiveHasMaterial; | 1 | bslbf |
| if (primitiveHasMaterial) { | | |
| primitiveMaterialId = GetID( ); | | |
| } | | |
| primitiveHasSpatialTransform; | 1 | bslbf |
| if (primitiveHasSpatialTransform) { | | |
| primitiveHasAnchor; | 1 | bslbf |
| if (primitiveHasAnchor) { | | |
| primitiveParentAnchorId = GetID( ); | | |
| } | | |
| else { | | |
| primitiveParentTransformId = GetID; | | |
| } | | |
| } | | |
| isPrimitiveStatic; | 1 | bslbf |
| isEarlyReflectionPrimitive; | 1 | bslbf |
| } | | |
| } | | |

| Syntax | No. of bits | Mnemonic |
|---|---|---|
| meshes( ) | | |
| { | | |
| meshesCount = GetCountOrIndex( ); | | |
| for (int i = 0; i < meshesCount; i++) { | | |
| meshId = GetID( ); | | |
| meshCodedLength; | 32 | uimsbf |
| meshFaces( ); | meshCodedLength | bslbf |
| [meshPositionX; | | |
| meshPositionY; | | |
| meshPositionZ;] = GetPosition(isSmallScene) | | |
| [meshOrientationYaw; | | |
| meshOrientationPitch; | | |
| meshOrientationRoll;] = GetOrientation( ) | | |
| meshCoordSpace; | 1 | bslbf |
| meshHasSpatial Transform; | 1 | bslbf |
| if (meshHasSpatialTransform) { | | |
| meshHasAnchor; | 1 | bslbf |
| if (meshHasAnchor) { | | |
| meshParentAnchorId = GetID( ); | | |
| } | | |
| else { | | |
| meshParentTransformId = GetID( ); | | |
| } | | |
| } | | |
| isMeshStatic; | 1 | bslbf |
| isEarlyReflectionMesh; | 1 | bslbf |
| } | | |
| } | | |

### Data Structure→Renderer Payloads→Geometry

To be amended: New section “6.3.2.1.2 Static geometry for Early Reflection and Diffraction Stage”.

### Data Structure→Renderer Payloads→Diffraction Payload Data Structure

To be amended: Section “6.3.2.3-Diffraction payload data structure”.

### Data Structure→Renderer Payloads→Scene Plus Payload Data Structure

In Section “6.3.2.10-Scene plus payload data structure” following descriptions shall be added:

| | |
|---|---|
| [. . .] | |
| isPrimitiveStatic | This flag indicates is the primitive is static or |
| | dynamic. If static, then the primitive is stationary |
| | throughout the entire duration of the scene, |
| | whereas the position of the primitive could be |
| | updated if it is dynamic. |
| isEarlyReflectionPrimitive | This flag indicates if the primitive is added by the |
| | geometry data converter to the static mesh for the |
| | Early Reflection Stage. |
| meshesCountThis | value is the number of meshes in this payload. |
| [. . .] | |
| isMeshStatic | This flag indicates is the mesh is static or dynamic. |
| | If static, then the mesh is stationary throughout the |
| | entire duration of the scene, whereas the position |
| | of the mesh could be updated if it is dynamic. |
| isEarlyReflectionMesh | This flag indicates if the mesh is added by the |
| | geometry data converter to the static mesh for the |
| | Early Reflection Stage. |
| environmentsCount | This value represents the number of acoustic |
| [. . .] | environments in this payload. |

It is noted that the runtime complexity of the renderer is not affected by the proposed changes.

In the following, test results are considered.

Evidence for the merit of this method is given below (see Table 2 and Table 3). In the Hospital scene as representative example, there are 95520 edgesInPathCount bitstream elements in diffrStaticPathDict( ) resulting in total in 568708 bits for these bitstream elements when writeCountOrIndex( ) is used. When using the Generic Codebook technique only 32 bits for the codebook config and 169611 bits for the encoded symbols are needed for encoding the same data. In diffrDynamicPaths( ) the edgesInPathCount bitstream element sums up to 15004 bits in total when using writeCountOrIndex( ) for the same scene vs. 160+6034=6194 bits when using the Generic Codebook technique.

Escaped integer values provided by the function writeID( ) are used for less frequently transmitted bitstream elements to replace fixed-length integer values.

The Core Experiment is based on RM1+, i.e. RM1 including the m60434 contribution (see [2]) which was accepted for being merged into the v23 reference model. The necessity of using this pre-release version comes from the fact that this Core Experiment utilizes the encoding techniques introduced in m60434.

In order to verify that the proposed method works correctly and to prove its technical merit, all “Test 1” and “Test 2” scenes were encoded and compared the size of the diffraction metadata with the encoding result of the RM1+ encoder.

For all “Test 1” and “Test 2” scenes, the proposed encoding method provides on average a reduction of 55.20% in overall bitstream size over RM1+. Considering only scenes with diffracting mesh data, the proposed encoding method provides on average a reduction of 73.53% in overall bitstream size over RM1+.

Regarding data compression, Table 1 lists the size of diffractionPayload( ) for the RM1+ encoder (“old size/bits”) and the proposed encoding method (“new size/bits”). The last column lists the achieved compression ratio, i.e. the ratio of the old and the new payload size.

In all cases the proposed method results in smaller payload sizes. For all scenes with diffracting scene objects that generate diffracted sound, i.e. scenes with mesh data, a compression ratio greater than 2.85 was achieved. For the largest scenes (“Park” and “Recreation”) compression ratios of 19.35 and 36.11 were achieved.

TABLE 1
size comparison of diffractionPayload( )

| | | | compression |
|---|---|---|---|
| Scene | old size/bits | new size/bits | ratio |
| ARBmw | 290 | 97 | 2.99 |
| ARHomeConcert_Test1 | 299 | 106 | 2.82 |
| ARPortal | 156311 | 24649 | 6.34 |
| Battle | 1231043 | 409843 | 3.00 |
| Beach | 299 | 106 | 2.82 |
| Canyon | 7376196 | 1592252 | 4.63 |
| Cathedral | 50801985 | 2968271 | 17.12 |
| DowntownDrummer | 1847318 | 199428 | 9.26 |
| GigAdvertisement | 290 | 97 | 2.99 |
| Hospital | 26262049 | 9205292 | 2.85 |
| OutsideHOA | 427631 | 27905 | 15.32 |
| Park | 115256140 | 3192053 | 36.11 |
| ParkingLot | 6854907 | 503082 | 13.63 |
| Recreation | 182289810 | 9421775 | 19.35 |
| SimpleMaze | 4504068 | 455236 | 9.89 |
| SingerInTheLab | 2456 | 315 | 7.80 |
| SingerInYourLab_small | 290 | 97 | 2.99 |
| VirtualBasketball | 1878590 | 88696 | 21.18 |
| VirtualPartition | 19102 | 2128 | 8.98 |

Table 2 and Table 3 summarize how many bits were spent in the Hospital scene for the bitstream elements of the diffrStaticPathDict( ) payload component. Since this scene can be regarded as a benchmark scene for diffraction, it is of special relevance. In RM1+ the “angle” bitstream element is responsible for more than 50% of the diffrStaticPathDict( ) payload component size in the Hospital scene. With 24 bit quantization for a comparable accuracy and Generic Codebook entropy encoding, the size of the diffrStaticPathDict( ) payload component can be significantly reduced as shown in Table 3. Please note that the labels given by the encoder are used to name the bitstream elements and that these may deviate from the bitstream element labels defined above.

TABLE 2
diffrStaticPathDict( ) payload component
of Hospital scene, RM1+ encoder

| Bitstream element | Type | Number | Bits total |
|---|---|---|---|
| relevantEdgeCount | UnsignedInteger | 1 | 16 |
| pathCount | UnsignedInteger | 1103 | 17648 |
| pathId | writeID | 95520 | 2160384 |
| edgesInPathCount | writeCountOrIndex | 95520 | 568708 |
| edgeId | writeID | 401303 | 6108928 |
| faceIndicator | UnsignedInteger | 401303 | 802606 |
| angle | Float32 | 401303 | 12841696 |
| TOTAL | | | 22499986 |

TABLE 3
diffrStaticPathDict( ) payload component
of Hospital scene, proposed encoder

| Bitstream element | Type | Number | Bits total |
|---|---|---|---|
| hasStaticPathsData | Flag | 1 | 1 |
| codebookEdgeIDSeqLen | CodebookConfig | 1 | 32 |
| codebookEdgeIDSeq | CodebookConfig | 1 | 14346 |
| codebookAngleSeq | CodebookConfig | 1 | 419387 |
| numBitsAngle | UnsignedInteger | 1 | 6 |
| relevantEdgeCount | writeID | 1 | 16 |
| pathCount | writeID | 1103 | 9648 |
| edgesInPathCount | CodebookSymbol | 95520 | 169611 |
| edgeID | CodebookSymbol | 401303 | 3071182 |
| faceIndicator | Flag | 401303 | 401303 |
| angle | CodebookSymbol | 401303 | 4750569 |
| TOTAL | | | 8836101 |

The benefit of the Voxel Coordinate Prediction is illustrated in Table 4 and Table 5 which summarize how many bits were spent in the Park scene for the bitstream elements of the diffrValidPathDict( ) payload component. Please note that the labels given by the encoder are used again to name the bitstream elements and that these may deviate from the bitstream element labels defined above.

Thanks to the Inter-Voxel Redundancy Reduction, there are much fewer occurances of the bitstream elements diffrValidPathEdge (“initialEdgeId”) and diffrValidPathPath (“pathIndex”) which are the main contributors to the size of the diffrValidPathDict( ) payload component for the Park scene in RM1+. Furthermore, in our proposed encoder the transmission of the voxel coordinates needs only a small fraction of the number of bits which were previously needed.

TABLE 4
diffrValidPathDict( ) payload component of Park scene, RM1+ encoder

| Bitstream element | Type | Number | Bits total |
|---|---|---|---|
| staticSourceCount | UnsignedInteger | 1 | 16 |
| sourceId | writeID | 3 | 24 |
| listenerVoxelCount | UnsignedInteger | 3 | 96 |
| voxelGridIndexX | UnsignedInteger | 119853 | 1917648 |
| voxelGridIndexY | UnsignedInteger | 119853 | 1917648 |
| voxelGridIndexZ | UnsignedInteger | 119853 | 1917648 |
| pathsPerSourceListenerPairCount | UnsignedInteger | 119853 | 1917648 |
| initialEdgeId | writeID | 1318347 | 20021576 |
| pathIndex | UnsignedInteger | 1318347 | 21093552 |
| TOTAL | | | 48785856 |

TABLE 5
diffrValidPathDict( ) payload component of Park scene, proposed encoder

| Bitstream element | Type | Number | Bits total |
|---|---|---|---|
| hasValidPaths | Flag | 1 | 1 |
| staticSourceCount | writeID | 1 | 8 |
| sourceId | writeID | 3 | 24 |
| codebookVcX | CodebookConfig | 3 | 60 |
| codebookVcY | CodebookConfig | 3 | 75 |
| codebookVcZ | CodebookConfig | 3 | 2241 |
| codebookNumPaths | CodebookConfig | 3 | 237 |
| codebookEdgeId | CodebookConfig | 3 | 5234 |
| codebookPathId | CodebookConfig | 3 | 3761 |
| codebookIndicesRemoved | CodebookConfig | 3 | 237 |
| listenerVoxelCount | writeID | 3 | 72 |
| hasVoxelCoordZ | Flag | 119853 | 119853 |
| voxelCoordZ | CodebookSymbol | 6855 | 39492 |
| hasVoxelCoordY | Flag | 6855 | 6855 |
| voxelCoordY | CodebookSymbol | 5541 | 8838 |
| hasVoxelCoordX | Flag | 5541 | 5541 |
| voxelCoordX | CodebookSymbol | 4884 | 39072 |
| voxelEncodingMode | UnsignedIntege | 119853 | 239706 |
| pathsPerSourceListenerPairCount | CodebookSymbol | 119853 | 141834 |
| initialEdgeId | CodebookSymbol | 23826 | 146291 |
| pathIndex | CodebookSymbol | 23826 | 137858 |
| listIndicesRemovedIncrement | CodebookSymbol | 140199 | 209161 |
| TOTAL | | | 1106451 |

A significant total bitstream saving is achieved. Table 6 lists the saving of total bitstream size in percent. On average, the total bitstream size was reduced by 55.20%. Considering only scenes with mesh data, the total bitstream sizes were reduced by 73.53% on average.

TABLE 6
saving of total bitstream size

| | old total size/ | new total size/ | saving/ |
|---|---|---|---|
| Scene | bytes | bytes | % |
| ARBmw | 2227 | 2187 | 1.80% |
| ARHomeConcert_Test1 | 555 | 515 | 7.21% |
| ARPortal | 19108 | 6879 | 64.00% |
| Battle | 174954 | 75157 | 57.04% |
| Beach | 816 | 776 | 4.90% |
| Canyon | 860305 | 239833 | 72.12% |
| Cathedral | 6474925 | 505521 | 92.19% |
| DowntownDrummer | 217588 | 36410 | 83.27% |
| GigAdvertisement | 938 | 898 | 4.26% |
| Hospital | 3261030 | 1179587 | 63.83% |
| OutsideHOA | 49457 | 12736 | 74.25% |
| Park | 14500165 | 598261 | 95.87% |
| ParkingLot | 952802 | 160090 | 83.20% |
| Recreation | 23516032 | 1772737 | 92.46% |
| SimpleMaze | 498816 | 98395 | 80.27% |
| SingerInTheLab | 5192 | 4830 | 6.97% |
| SingerInYourLab_small | 3451 | 3411 | 1.16% |
| VirtualBasketball | 240432 | 20826 | 91.34% |
| VirtualPartition | 2265 | 620 | 72.63% |

Summarizing, in the above, an improved binary encoding of diffractionPayload( ) and a geometry data converter which avoids re-transmission of static mesh data has been provided. For a test set comprising 19 AR and VR scenes, the size of the encoded bitstreams with the output of the RM1+ encoder has been compared.

Besides the mesh approximation of geometric primitives as part of the geometry data converter and changed numbering of vertices and triangles, the proposed encoding method features only negligible deviations caused by the 24-bit quantization of angular floating point values. All other bitstream elements are encoded losslessly.

In all cases the proposed concepts result in smaller payload sizes. For all “test 1” and “test 2” scenes, the proposed encoding method provides on average a reduction of 55.20% in overall bitstream size over RM1+. Considering only scenes with reflecting mesh data, the proposed encoding method provides on average a reduction of 73.53% in overall bitstream size over RM1+.

Moreover, the proposed encoding method does not affect the runtime complexity of a renderer.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] ISO/IEC JTC1/SC29/WG6 M61258 “Third version of Text of Working Draft of RM0”, 8th WG 6 meeting, October 2022.
[2] ISO/IEC JTC1/SC29/WG6 M60434 “Core Experiment on Binary Encoding of Early Reflection Metadata”, 7th WG 6 meeting, July 2022.

1. An apparatus, comprising
a receiving interface, wherein the receiving interface is configured for receiving first data comprising information on one or more acoustic properties of an environment and/or one or more objects of an environment comprising acoustic properties and/or one or more objects of an environment comprising acoustic properties and/or comprising one or more audio signals and/or comprising metadata on the one or more audio signals and/or comprising video data; and wherein the receiving interface is configured for receiving spatial data, wherein the spatial data defines at least one area or at least one spatial volume, wherein the first data is associated with the spatial data; and
a data processor, configured for processing the first data to acquire processed data depending on the spatial data.

2. An apparatus according to claim 1,
wherein the spatial data comprises encoded position data, wherein the encoded position data encodes a plurality of positions, wherein the positions together define the at least one area or the at least one spatial volume; wherein the first data is associated with the plurality of positions; and
wherein the data processor is configured for decoding the encoded position data to acquire the plurality of positions.

3. An apparatus according to claim 2,
wherein the first data comprises said information on the one or more acoustic properties of the environment and/or comprises said one or more audio signals and/or comprises said metadata on the one or more audio signals.

4. An apparatus according to claim 3,
wherein the apparatus comprises an audio signal generator for generating one or more audio output signals depending on the processed data.

5. An apparatus according to claim 3,
wherein the first data comprises said information on the one or more acoustic properties of the environment, which comprises information on one or more reflection objects and/or comprises information on one or more diffraction objects which are in a line-of-sight from a position of the plurality of positions.

6. An apparatus according to claim 3,
wherein the first data comprises one or more audio source signals, wherein each audio source signal of the one or more audio source signals is associated with a position of the plurality of positions which indicates a sound source position of said audio source signal.

7. An apparatus according to claim 2,
wherein the first data comprises said video data.

8. An apparatus according to claim 7,
wherein the apparatus comprises a video signal generator for generating one or more video output signals depending on the processed data.

9. An apparatus according to claim 8,
wherein the video signal generator is configured to generate the one or more video output signals comprising video data depending on the first data and depending on the plurality of positions.

10. An apparatus according to claim 4,
wherein the apparatus comprises a video signal generator for generating one or more video output signals depending on the processed data,
wherein the audio signal generator is configured to generate the one or more audio output signals for an augmented reality application or for a virtual reality application, and
wherein the video signal generator is configured to generate the one or more video output signals for the augmented reality application or for the virtual reality application.

11. An apparatus according to claim 2,
wherein the receiving interface is configured to receive a data stream comprising the first data and the encoded position data.

12. An apparatus according to claim 11,
wherein the receiving interface is configured for receiving the encoded position data encoding the plurality of positions, being a plurality of positions of a coordinate system, which exhibits two or more dimensions.

13. An apparatus according to claim 12,
wherein, if coordinate information of the encoded position data for a first coordinate value of a considered position of the plurality of positions indicates a first state, the data processor is configured to determine the first coordinate value of the considered position by incrementing or decrementing a first coordinate value of a previously decoded position of the plurality of positions, and
wherein, if the coordinate information of the encoded position data for the first coordinate value of the considered position indicates a second state being different from the first state, the data processor is configured to determine the first coordinate value of the considered position without using the previously decoded position for determining the first coordinate value of the considered position.

14. An apparatus according to claim 13,
wherein, if the coordinate information of the encoded position data for the first coordinate value of the considered position indicates the first state, the data processor is configured to employ one or more other coordinate values of the previously decoded position as one or more other coordinate values of the considered position.

15. An apparatus according to claim 13,
wherein the data stream comprises the first data immediately after coordinate information of one of two or more coordinate values of a position of the plurality of positions, with which the first data is associated,
wherein the apparatus is configured to acquire the first data from the data stream.

16. An apparatus according to claim 13,
wherein the first data of the data stream is encoded first data, wherein a portion of the encoded first data being associated with a first position of the plurality of positions is encoded depending on a portion of the encoded first data being associated with a second position of the plurality of positions.

17. An apparatus according to claim 16,
wherein the second position exhibits a coordinate value immediately preceding or immediately succeeding a coordinate value of the first position among the plurality of positions with respect to a coordinate of the two or more coordinates of the coordinate system.

18. An apparatus according to claim 12,
wherein, if the coordinate information of the encoded position data for the first coordinate value of the considered position indicates the second state, the data processor is configured to determine the first coordinate value of the considered position from an entropy encoding of the first coordinate value within the data stream.

19. An apparatus according to claim 12,
wherein, if the coordinate information of the encoded position data for the first coordinate value of the considered position indicates the second state, the encoded position data comprises coordinate information for a second coordinate value of the considered position, and the data processor is configured to determine the second coordinate value of the considered position depending on the coordinate information of the encoded position data for the second coordinate value.

20. An apparatus according to claim 19,
wherein, if the coordinate information of the encoded position data for the second coordinate value of the considered position indicates a first state, the data processor is configured to determine the second coordinate value of the considered position by incrementing or decrementing a second coordinate value of the previously decoded position of the plurality of positions, and
wherein, if the coordinate information of the encoded position data for second first coordinate value of the considered position indicates a second state being different from said first state, the data processor is configured to determine the second coordinate value of the considered position from the data stream without using the previously decoded position for determining the second coordinate value of the considered position.

21. An apparatus according to claim 12,
wherein the plurality of positions indicates a plurality of positions of voxels.

22. An apparatus according to claim 12,
wherein the spatial data comprises information on at least one rectangle to define the at least one area; or wherein the spatial data comprises information at least one cuboid to define the at least one spatial volume.

23. An apparatus according to claim 22,
wherein the plurality of positions of the coordinate system define the corners of the at least one rectangle, or
wherein the plurality of positions of the coordinate system define the corners of the at least one cuboid.

24. An apparatus according to claim 22,
wherein the spatial data comprises information on at least two rectangles to define the one of the at least one area; or wherein the spatial data comprises information at least two cuboids to define one of the at least one spatial volume.

25. An apparatus according to claim 22,
wherein the coordinate system exhibits more than three dimensions.

26. An apparatus according to claim 1,
wherein the spatial data comprises boundary data, wherein the boundary data defines the at least one area or the at least one spatial volume; wherein the first data is associated with the boundary data.

27. An apparatus according to claim 26,
wherein the boundary data comprises a width and a height to define the at least one area being a two-dimensional area; or
wherein the boundary data comprises a width and a height and a length define the at least one area being a three-dimensional area.

28. An apparatus, comprising
an output generator, wherein the output generator is configured for generating spatial data, wherein the spatial data defines at least one area or at least one spatial volume;
an output interface for outputting first data and the spatial data; wherein the first data comprises information on one or more acoustic properties of an environment and/or one or more objects of an environment comprising acoustic properties and/or comprises one or more audio signals and/or comprises metadata on the one or more audio signals and/or comprises video data; wherein the first data is associated with the spatial data.

29. An apparatus according to claim 28,
wherein the output generator is configured to generate the spatial data such that the spatial data comprises encoded position data, wherein the encoded position data encodes a plurality of positions, wherein the positions together define the at least one area or the at least one spatial volume; wherein the first data is associated with the plurality of positions.

30. An apparatus according to claim 29,
wherein the first data comprises said information on the one or more acoustic properties of the environment and/or comprises said one or more audio signals and/or comprises said metadata on the one or more audio signals.

31. An apparatus according to claim 30,
wherein the first data comprises said information on the one or more acoustic properties of the environment, which comprises information on one or more reflection objects and/or comprises information on one or more diffraction objects which are in a line-of-sight from a position of the plurality of positions.

32. An apparatus according to claim 30,
wherein the first data comprises one or more audio source signals, wherein each audio source signal of the one or more audio source signals is associated with a position of the plurality of positions which indicates a sound source position of said audio source signal.

33. An apparatus according to claim 29,
wherein the first data comprises said video data.

34. An apparatus according to claim 29,
wherein the output generator is configured to generate a data stream comprising the first data and the encoded position data, and
wherein the output interface is configured to output the data stream.

35. An apparatus according to claim 34,
wherein the output generator is configured to generate the encoded position data, such that the encoded position data encodes the plurality of positions, being a plurality of positions of a coordinate system, which exhibits two or more dimensions.

36. An apparatus according to claim 35,
wherein the output generator is configured to generate the encoded position data, such that the encoded position data comprises coordinate information for a first coordinate value of one of the plurality of positions, which indicates a first state, wherein the first state indicates that the first coordinate value of said one of the plurality of positions corresponds to a modified value being a first coordinate value of a previously encoded position of the plurality of positions which is incremented or decremented by a predefined value, and
wherein the output generator is configured to generate the encoded position data, such that the encoded position data comprises coordinate information for a first coordinate value of another one of the plurality of positions, which indicates a second state being different from the first state, wherein the second state indicates that the first coordinate value of said other one of the plurality of positions is comprised by or encoded within the encoded position data and is acquirable or decodable from the encoded position data without using a first coordinate value of any other one of the plurality of positions.

37. An apparatus according to claim 36,
wherein the first state indicates that one or more other coordinate values of said one of the plurality of positions correspond to one or more other coordinate values of the previously encoded position.

38. An apparatus according to claim 36,
wherein the data stream comprises the first data immediately after coordinate information of one of two or more coordinate values of a position of the plurality of positions, with which the first data is associated.

39. An apparatus according to claim 36,
wherein the first data of the data stream is encoded first data, wherein a portion of the encoded first data being associated with a first position of the plurality of positions is encoded depending on a portion of the encoded first data being associated with a second position of the plurality of positions.

40. An apparatus according to claim 39,
wherein the second position exhibits a coordinate value immediately preceding or immediately succeeding a coordinate value of the first position among the plurality of positions with respect to a coordinate of the two or more coordinates of the coordinate system.

41. An apparatus according to claim 35,
wherein the coordinate information of the encoded position data for the first coordinate value of said other one of the plurality of positions indicates the second state, and the encoding module is configured to generate the encoded position data such that the encoded position data comprises coordinate information for a second coordinate value of said other one of the plurality of positions.

42. An apparatus according to claim 41,
wherein the output generator is configured to generate the encoded position data, such that the encoded position data comprises coordinate information for the second coordinate value of said other one of the plurality of positions, which indicates a first state, wherein the first state indicates that the second coordinate value of said other one of the plurality of positions corresponds to another modified value being a second coordinate value of a previously encoded position of the plurality of positions which is incremented or decremented by another predefined value, or
wherein the output generator is configured to generate the encoded position data, such that the encoded position data comprises coordinate information for the second coordinate value of said other one of the plurality of positions, which indicates a second state being different from the first state, wherein the second state indicates that the second coordinate value of said other one of the plurality of positions is comprised by or encoded within the encoded position data and is acquirable or decodable from the encoded position data without using a second coordinate value of any other one of the plurality of positions.

43. An apparatus according to claim 39,
wherein the plurality of positions indicates a plurality of positions of voxels.

44. An apparatus according to claim 35,
wherein the spatial data comprises information on at least one rectangle to define the at least one area; or wherein the spatial data comprises information at least one cuboid to define the at least one spatial volume.

45. An apparatus according to claim 44,
wherein the plurality of positions of the coordinate system define the corners of the at least one rectangle, or
wherein the plurality of positions of the coordinate system define the corners of the at least one cuboid.

46. An apparatus according to claim 44,
wherein the spatial data comprises information on at least two rectangles to define the one of the at least one area; or wherein the spatial data comprises information at least two cuboids to define one of the at least one spatial volume.

47. An apparatus according to claim 35,
wherein the coordinate system exhibits more than three dimensions.

48. An apparatus according to claim 28,
wherein the spatial data comprises boundary data, wherein the boundary data defines the at least one area or the at least one spatial volume; wherein the first data is associated with the boundary data.

49. An apparatus according to claim 48,
wherein the boundary data comprises a width and a height to define the at least one area being a two-dimensional area; or
wherein the boundary data comprises a width and a height and a length define the at least one area being a three-dimensional area.

50. A system, comprising:
an apparatus according to claim 28, and
an apparatus according to claim 1,
wherein the apparatus according to claim 1 is configured to receive the first data and the spatial data from the apparatus according to claim 28.

51. A method, comprising
receiving first data comprising information on one or more acoustic properties of an environment and/or one or more objects of an environment comprising acoustic properties and/or comprising one or more audio signals and/or comprising metadata on the one or more audio signals and/or comprising video data;
receiving spatial data, wherein the spatial data defines at least one area or at least one spatial volume, wherein the first data is associated with the spatial data; and
processing the first data to acquire processed data depending on the spatial data.

52. A method, comprising:
generating spatial data, wherein the spatial data defines at least one area or at least one spatial volume; and
outputting first data and the spatial data; wherein the first data comprises information on one or more acoustic properties of an environment and/or one or more objects of an environment comprising acoustic properties and/or comprises one or more audio signals and/or comprises metadata on the one or more audio signals and/or comprises video data; wherein the first data is associated with the spatial data.

53. A non-transitory digital storage medium having a computer program stored thereon to perform the method comprising:
receiving first data comprising information on one or more acoustic properties of an environment and/or one or more objects of an environment comprising acoustic properties and/or comprising one or more audio signals and/or comprising metadata on the one or more audio signals and/or comprising video data;
receiving spatial data, wherein the spatial data defines at least one area or at least one spatial volume, wherein the first data is associated with the spatial data; and
processing the first data to acquire processed data depending on the spatial data, when said computer program is run by a computer.

54. A non-transitory digital storage medium having a computer program stored thereon to perform the method comprising:
generating spatial data, wherein the spatial data defines at least one area or at least one spatial volume; and
outputting first data and the spatial data; wherein the first data comprises information on one or more acoustic properties of an environment and/or one or more objects of an environment comprising acoustic properties and/or comprises one or more audio signals and/or comprises metadata on the one or more audio signals and/or comprises video data; wherein the first data is associated with the spatial data,
when said computer program is run by a computer.
